(19) United States
(12) Patent Application Publication
(10) Pub. No.: US 2003/0107328 A1
(43) Pub. Date: Jun. 12, 2003

(54) Neon light control device

(76) Inventor: Lin-Kuei Ling, Shanghai (CN)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/010,206

(22) Filed: Dec. 6, 2001

(51) Int. Cl. H05B 37/02; H05B 41/16

(52) U.S. Cl. 315/276; 315/291

(57) ABSTRACT

A neon light control device has a control box and at least one voltage transformer, wherein the control box has multiple outlet ports and the voltage transformer has an inlet port and an outlet port. The voltage transformer is detachably connected to the control box by a wire between one of the outlet ports and one of the inlet ports. When either the control box or the voltage transformer has a breakdown, only the damaged element needs to be repaired or replaced. Thus the replacement of the entire control device is not necessary.

### BACKGROUND OF THE INVENTION

1. Field of Invention

The present invention relates to a neon light control device, and more particularly to a control device that uses a control box and detachable voltage transformers to control neon lights.

2. Related Art

Neon lights are often used as advertisement devices. Conventional use of neon lights selectively turns the lights on and off to form different patterns to attract people's attention. Generally, a control box is used to turn the neon lights on and off. The control box is connected to multiple voltage transformers, and each voltage transformer is connected to neon light. when the control box selectively activates a specific voltage transformer, the neon light connected to that transformer is turned on.

However, the voltage transformer is permanently connected to the control box. Consequently if either the control box or the voltage transformer is damaged, both must be replaced with new ones simultaneously. Therefore, repair to a damage or faulty neon light advertising device is very inefficient and expensive for a user.

To overcome the shortcomings, the present invention provides a neon light control device to mitigate and obviate the aforementioned problems.

### SUMMARY OF THE INVENTION

An objective of the invention is to provide a neon light control device that is able to reduce and minimize repair costs when the control device breaks down.

To achieve the objective of the invention, the neon light control device comprises a control box with multiple connecting ports, and at least one voltage transformer detachably connected to one of the multiple connecting ports.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a neon light control device in accordance with the present invention;

FIG. 2 is an operational perspective view of the neon light control device in FIG. 1, with a control box individually connected to two voltage transformers; and

FIG. 3 is an operational perspective view of the neon light control device in FIG. 1, with two voltage transformers connected sequentially to the control box.

### DETAILED DESCRIPTION OF THE INVENTION

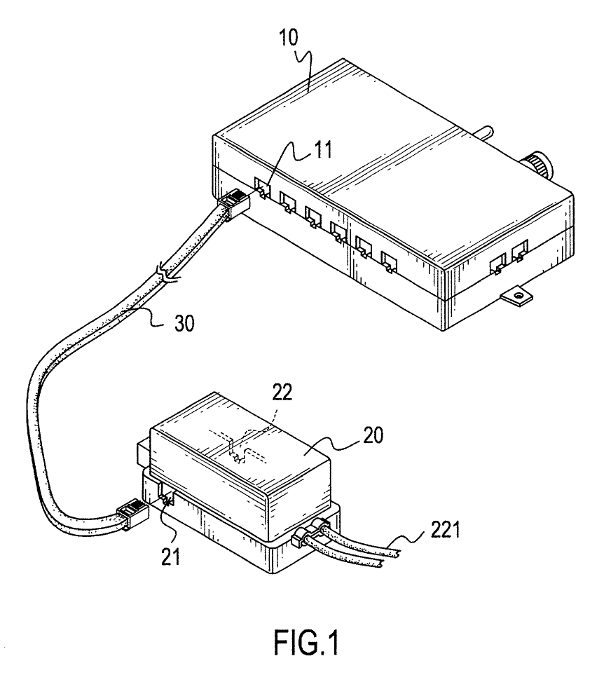

With reference to FIG. 1, a neon light control device in accordance with the present invention comprises a control box (10) and at least one voltage transformer (20). The control box (10) has multiple outlet ports (11), and each voltage transformer (20) has an inlet port (21) and an outlet port (22). A wire (30) is detachably connected between one of the outlet ports (11) in the control box (10) and the inlet ports (21) in one of the voltage transformers (20) to electrically connect the control box (10) to the voltage transformer (20). The voltage transformer (20) further has power output wires (23) to connect to neon lights (not shown).

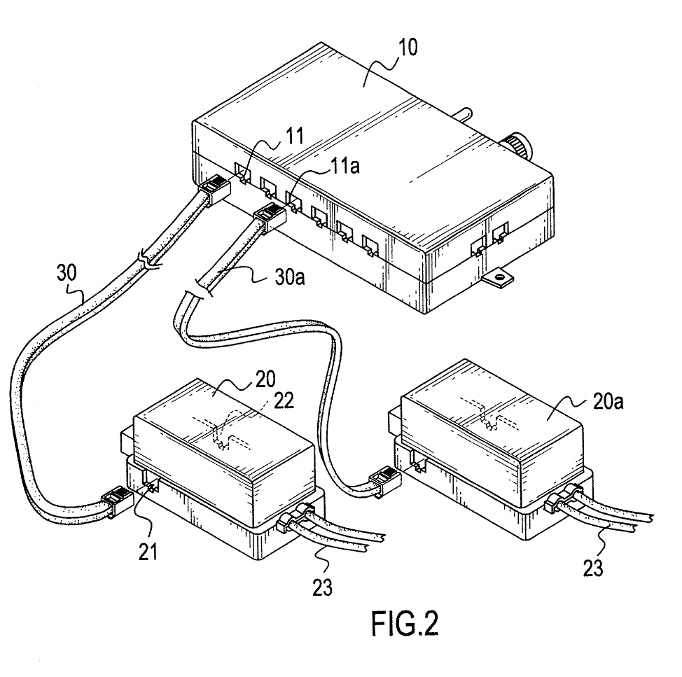

With reference to FIG. 2, in a practical application, the control box (10) is operated in coordination with multiple voltage transformers (20, 20a). A first embodiment only has two voltage transformers (20, 20a) individually connected to the control box (10). Each voltage transformer (20, 20a) is respectively connected to one of the outlet ports (11, 11a) by wires (30, 30a). When the control box (10) selectively provides power to the voltage transformers (20, 20a) through the wires (30, 30a), the voltage transformers (20, 20a) can transform the power to an operating voltage and output the operating voltage to the neon lights (not shown) through the power output wires (23). For example, if power is only provided to one voltage transformer (20), only the neon lights connected to that voltage transformer (20) can be turned on, and the neon lights connected to the other voltage transformer (20a) are “off.”

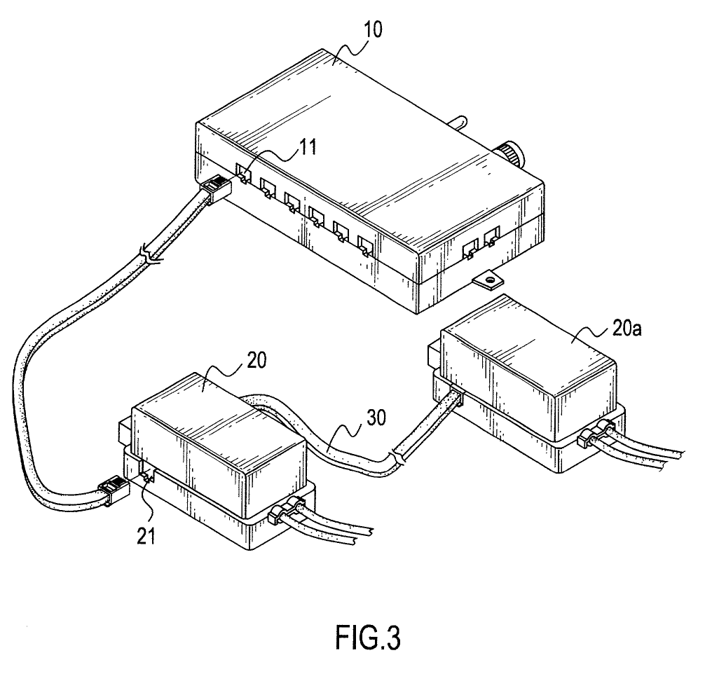

With reference to FIG. 3, the control box (10) is also connected to two voltage transformers (20, 20a). However the two voltage transformers (20, 20a) in this embodiment are connected sequentially by a wire (30) between the two voltage transformer (20, 20a) to a single outlet port (11) in the control box (10). When the control box (10) provides power to the two voltage transformers (20, 20a), the two voltage transformers (20, 20a) simultaneously output operating voltages to the neon lights (not shown) to turn on the neon lights.

In the second embodiment, the control box (10) only uses a connecting port (11) to drives the two voltage transformers (20, 20a). Thus the remaining connecting ports (11) can be used to drive other voltage transformers. In other words, the control box (10) in the second embodiment can control more neon lights than prior techniques.

If the control box or the voltage transformer in either embodiment is damaged, the user only needs to repair or replace the damaged element, thereby reducing the repair cost.

The invention may be varied in many ways by a skilled person in the art. Such variations are not to be regarded as a departure from the spirit and scope of the invention, and all such modifications are intended to be included within the scope of the following claims.

What is claimed is:

1. A neon light device comprising:
a control box with multiple outlet ports; and
at least one voltage transformer having at least one inlet port and one outlet port and detachably connected to the control box through a wire that is connected between one of the outlet ports in the control box and the inlet port in the voltage transformer, wherein the at least one voltage transformer further has a power output wire adapted to connect to neon lights;
wherein when the control box provides power to the at least one voltage transformer, the at least one voltage transformer outputs an operating voltage to the neon lights to turn on the neon lights.

2. The neon light device as claimed in claim 1 comprising multiple voltage transformers connected in sequence by wires between the outlet port of one transformer and the inlet port of a subsequent voltage transformer.
